(19) United States
(12) Patent Application Publication
(10) Pub. No.: US 2007/0109956 A1
(43) Pub. Date: May 17, 2007

(54) Apparatus and method for transmitting and receiving data in a frequency division multiple access system, and system thereof

(75) Inventors: Hwan-Joon Kwon, Hwaseong-si (KR); Yu-Chul Kim, Seoul (KR); Dong-Hee Kim, Yongin-si (KR); Jae-Chon Yu, Suwon-si (KR); Jin-Kyu Han, Seoul (KR); Young-Bum Kim, Seoul (KR); Ju-Ho Lee, Suwon-si (KR); Youn-Hyoung Heo, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/512,407

(22) Filed: Aug. 30, 2006

(30) Foreign Application Priority Data
Aug. 30, 2005 (KR) 2005-80031
Jun. 21, 2006 (KR) 2006-56036

(51) Int. Cl. H04J 11/00

(52) U.S. Cl. 370/208

(57) ABSTRACT

An apparatus and method for transmitting and receiving data in an Orthogonal Frequency Division Multiple Access (OFDMA) system using a plurality of resource blocks are provided, in which a transmitter generates a sub-packet to perform a Hybrid Automatic Repeat reQuest (HARQ) function on the data, performs interleaving on the generated sub-packet for each resource block for a receiver according to predetermined order, and transmits a control message including the sub-packet for each resource block and allocation information of the sub-packet to mobile stations. A mobile station deinterleaves the sub-packet received from the base station for each resource block, and combines the deinterleaved sub-packet based on the control message.

### PRIORITY

This application claims the benefit under 35 U.S.C. § 119(a) of a Korean Patent Application filed in the Korean Intellectual Property Office on Aug. 30, 2005 and assigned Serial No. 2005-80031, and a Korean Patent Application filed in the Korean Intellectual Property Office on Jun. 21, 2006 and assigned Serial No. 2006-56036, the entire disclosure of both of which are hereby incorporated by reference.

### BACKGROUND OF THE INVENTION

1. Field of the Invention

The present invention relates generally to an apparatus and method for transmitting and receiving data in a mobile communication system. More particularly, the present invention relates to an apparatus and method for transmitting and receiving data in an Orthogonal Frequency Division Multiple Access (OFDMA) system, and a system thereof.

2. Description of the Related Art

A mobile communication system has been developed to provide communication services to users regardless of location of the users. For communication, the mobile communication system identifies the users with its limited resources. There are various possible access schemes according to how to use the limited resources. For example, a scheme of identifying users with specific code resources is called a Code Division Multiple Access (CDMA) scheme, a scheme of identifying users with time resources is called a Time Division Multiple Access (TDMA) scheme, and a scheme of identifying users with frequency resources is called a Frequency Division Multiple Access (FDMA) scheme.

Each of the schemes can be subdivided into various types, and more than two schemes can be used on a combined basis. For example, a FDMA-based communication method of allocating unique orthogonal frequency resource to every user in a specific method is called an Orthogonal Frequency Division Multiple Access (OFDMA) scheme. Therefore, the OFDMA scheme is a type of the FDMA scheme.

The OFDMA, a scheme of transmitting data using multiple carriers, is a type of Multi-Carrier Modulation (MCM) that converts a serial input symbol stream into parallel symbol streams and modulates each of the symbol streams with a plurality of orthogonal sub-carriers, that is, a plurality of orthogonal sub-carrier channels, before transmission. A communication system using the OFDMA scheme will be referred to as an OFDMA system.

A description will now be made of a method for transmitting and receiving data in the current OFDMA system. FIG. 1 is a graph illustrating exemplary resource allocation distribution in the OFDMA system. In FIG. 1, the horizontal axis represents a time axis, and the vertical axis represents a frequency axis.

Referring to FIG. 1, reference numeral 101 represents a unit in which resources are reallocated in the time axis. Reference numerals 102, 103 and 104 represent a first band, an (N−1)th band, and an Nth band, respectively, when the full frequency band of the system is divided into N bands. Herein, each of the frequency. bands will also be called a sub-band. In the following description, the frequency band and the sub-band will be used in the same meaning. The frequency band is logically divided. Physically, however, one sub-band can be composed of either consecutive sub-carriers or spaced sub-carriers. The OFDMA system adopts a scheme of transmitting multi-user data by dividing time and frequency resources. In the following description, one block in a time-frequency domain shown in FIG. 1 will be referred to as a resource block.

Meanwhile, from the blocks represented by reference numerals 105 and 106, it can be understood in FIG. 1 that several resource blocks may be simultaneously allocated to one user. For example, resource blocks 105, 106 and 107 are allocated to a mobile station (MS) #2. The allocation method is determined by taking into account several external factors such as a channel situation.

FIG. 2 is a diagram illustrating a transmitter for transmitting user data in an OFDMA system. Referring to FIG. 2, a Cyclic Redundancy Check (CRC) adder 201 adds CRC bits to transmission user data, and delivers the CRC-added user data to a turbo coder 203. The turbo coder 203 codes the user data using a specific method, and delivers the coded bits to a Hybrid Automatic Repeat reQuest (HARQ) function unit 205. The HARQ function unit 205 receiving the coded bits performs a HARQ function in a physical layer (Layer 1). That is, the HARQ function unit 205 selects the coded bits that it intends to transmit in the current transmission interval, among the coded bits output from the turbo coder 203. The coded bits transmitted in the current transmission interval are commonly called a sub-packet. The sub-packet is composed of systematic bits which are actual data, and parity bits which are additional information.

The sub-packet generated by the HARQ function unit 205 is input to a sub-packet interleaver 207 where the systematic bits and the parity bits are mixed (or permutated) according to a specific rule for interleaving. Thereafter, the sub-packet interleaver 207 delivers the interleaved output signal to a resource block distributor 209.

The resource block distributor 209 serves to distribute the interleaved coded bits to a plurality of resource blocks allocated to a corresponding user. For example, if the number of the interleaved coded bits is 400, the number of resource blocks allocated to the user is 4, and the number of coded bits carried by each resource block is 100, the resource block distributor 209 divides the 400 interleaved coded bits into 100-bit resource blocks.

A modulator 210 is composed of N modulators 210-1 to 210-N. Each of the modulators 210-1 to 210-N performs a modulation process (for. example, QPSK, 8PSK, 16QAM, and the like) on the interleaved coded bits distributed from the resource block distributor 209. The modulated bits are allocated to each resource block 220 and transmitted to a mobile station (MS).

In the OFDMA system, as described above, the resource blocks are transmitted through different frequency bands in the frequency domain, and the general wireless channel environment is different for each individual frequency band. In other words, a Signal to Noise Ratio (SNR) of each resource block is different. In this environment, when a plurality of resource blocks are allocated to one user, the systematic bits and the parity bits are first mixed, and then allocated to each resource block. That is, the systematic bits and the parity bits are mixed in a plurality of resource blocks having different SNRs, before being transmitted, thereby causing a system performance deterioration problem that the parity bits may be mixed in higher-SNR resource blocks and the systematic bits may be mixed in lower-SNR resource blocks.

Accordingly, there is a need for an improved apparatus and method for increasing data transmission and reception reliability in a frequency division multiple access system.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a data transmission and reception apparatus and method for increasing system transmission efficiency in an OFDMA system using a plurality of resource blocks.

It is another aspect of exemplary embodiments of the present invention to provide a data transmission and reception apparatus and method for allocating data for each resource block in an OFDMA system using a plurality of resource blocks.

It is a further aspect of exemplary embodiments of the present invention to provide a data transmission and reception apparatus and method for transmitting system bits with a better channel environment in an OFDMA system using a plurality of resource blocks.

It is yet another aspect of exemplary embodiments of the present invention to provide a data transmission and reception apparatus and method for allocating resources taking overall channel situations into account in an OFDMA system using a plurality of resource blocks.

According to one aspect of exemplary embodiments of the present invention, there is provided a transmission method in an Orthogonal Frequency Division Multiple Access (OFDMA) system using a plurality of resource blocks, in which a sub-packet is generated to perform a Hybrid Automatic Repeat reQuest (HARQ) function on channel-coded data; the sub-packet to each resource block is distributed; the sub-packet distributed to each resource block is interleaved; the interleaved sub-packet is transmitted to a receiver; order of a plurality of allocated resource blocks is determined according to reliability; a control message including a distribution information of the sub-packet is generated; and the generated control message is transmitted to a receiver.

In an exemplary implementation, the reliability determined in the determining of the order comprises measuring a signal-to-noise ratio (SNR) of resource blocks allocated to a particular mobile station based on channel state information received from the mobile station, and determining reliability according to the SNR and a modulation scheme of the sub-packet.

In another exemplary implementation, the control message comprises information comprising the number of allocated resource blocks and distribution order of the sub-packet.

According to another aspect of exemplary embodiments of the present invention, there is provided a transmitter in an Orthogonal Frequency Division Multiple Access (OFDMA) system using a plurality of resource blocks, in which a Hybrid Automatic Repeat reQuest (HARQ) function unit generates a sub-packet to perform a HARQ function on channel-coded data; a resource block distributor distributes the sub-packet to each resource block; a plurality of resource block interleavers interleave the sub-packet distributed to each resource block; a controller generates a control message including a distribution information of the sub-packet; and a transmission unit transmits the generated control message to a receiver.

In an exemplary implementation, the resource block distributor comprises a priority determiner for determining priority of resource blocks allocated to a particular mobile station according to reliability based on channel state information received from the mobile station; and a resource allocator for allocating the generated sub-packet for each resource block based on the determined order.

In another exemplary implementation, the reliability is determined according to a signal-to-noise ratio (SNR) of allocated resource blocks and a modulation scheme of the sub-packet.

According to a further aspect of exemplary embodiments of the present invention, there is provided a reception method in an Orthogonal Frequency Division Multiple Access (OFDMA) system using a plurality of resource blocks, in which a data to each resource and an control message including distribution information of data are received from a transmitter, and the data distributed to each resource block is deinterleaved; the data deinterleaved for each resource block based on the control message is combined, and a sub-packet is outputted; a Hybrid Automatic Repeat reQuest (HARQ) function on the sub-packet is performed; and the sub-packet that underwent the HARQ function is decoded.

According to yet another aspect of exemplary embodiments of the present invention, there is provided a receiver of an Orthogonal Frequency Division Multiple Access (OFDMA) system using a plurality of resource blocks, in which a reception unit receives a data distributed to each resource and a control message including distribution information of the data from a transmitter; a plurality of resource block deinterleavers deinterleave the data to each resource block; a resource block combiner combines the data deinterleaved for each resource block based on the control message and outputs a sub-packet; a Hybrid Automatic Repeat reQuest (HARQ) function unit performs a HARQ function on the sub-packet; and a decoder decodes the sub-packet that underwent the HARQ function.

In an exemplary implementation, the resource block combiner comprises a resource allocation information acquirer for determining priority of the sub-packet for each resource block based on the control message; and a received signal extractor for combining the sub-packet for each resource block based on the priority provided from the resource allocation information acquirer.

According to still another aspect of exemplary embodiments of the present invention, there is provided a method for transmitting data in an Orthogonal Frequency Division Multiple Access (OFDMA) system using a plurality of resource blocks, in which order of allocated resource blocks is determined according to reliability of allocated resources; data to be transmitted to the receiver to a resource block is distributed according to the order; a control message including distribution information of the data is generated; and the data and the control message is transmitted to the receiver.

According to still another aspect of exemplary embodiments of the present invention, there is provided a transmitter in an Orthogonal Frequency Division Multiple Access (OFDMA) system using a plurality of resource blocks, in which a priority determiner determines order of allocated resource blocks according to reliability of the allocated resources; a resource allocator distributes data to be transmitted to a resource block according to the order and generates a control message including distribution information of the data; and a transmission unit transmits the data and the control message.

According to still another aspect of exemplary embodiments of the present invention, there is provided a receiver in an Orthogonal Frequency Division Multiple Access (OFDMA) system using a plurality of resource blocks, in which a reception unit receives a signal from a transmitter and converts the received signal into a baseband signal; a resource allocation information acquirer extracts a control message including distribution information of data in the converted signal and acquires order information of an allocated resource; and a received signal extractor sequentially extracts received signals from the allocated resource according to the order information of the allocated resource.

### BRIEF DESCRIPTION OF THE DRAWINGS

The above and other objects, features and advantages of certain exemplary embodiments of the present invention will be more apparent from the following detailed description taken in conjunction with the accompanying drawings, in which:

FIG. 1 is a graph illustrating an exemplary method for transmitting data to several users in an OFDMA system;

FIG. 2 is a diagram illustrating a transmitter for transmitting user data in an OFDMA system;

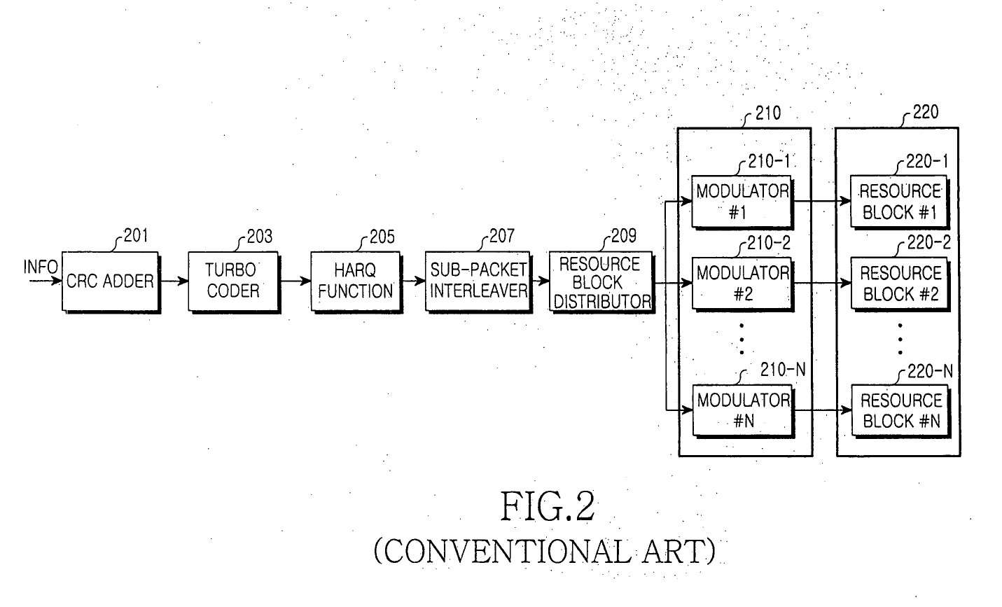

FIG. 3 is a block diagram illustrating a base station in an OFDMA system according to an exemplary embodiment of the present invention;

FIG. 4 is a diagram illustrating an exemplary method of allocating a sub-packet according to an exemplary embodiment of the present invention;

FIG. 5 is a flowchart illustrating a data transmission method in a base station according to an exemplary embodiment of the present invention;

FIG. 6 is a block diagram illustrating a mobile station in an OFDMA system according to an exemplary embodiment of the present invention;

FIG. 7 is a flowchart illustrating a method for receiving data in a mobile station according to an exemplary embodiment of the present invention;

FIG. 8 is a block diagram illustrating a structure of the resource block distributor of FIG. 3;

FIG. 9 is a flowchart illustrating a method for allocating data by a resource block distributor according to an exemplary embodiment of the present invention;

FIG. 10 is a block diagram illustrating a structure of a resource block combiner according to an exemplary embodiment of the present invention; and

FIG. 11 is a flowchart illustrating a method for combining data by a resource block combiner according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention proposes a method for determining resource allocation priority for resource blocks allocated to a specific user according to reliability based on overall channel situations and allocating systematic bits and parity bits for each resource block according to a priority in order to transmit the systematic bits among the coded bits in a better channel environment in an Orthogonal Frequency Division Multiple Access (OFDMA) system, and a transceiver thereof.

A transceiver, according to an exemplary embodiment of the present invention, will first be described, and then a method for allocating resources for data will be described.

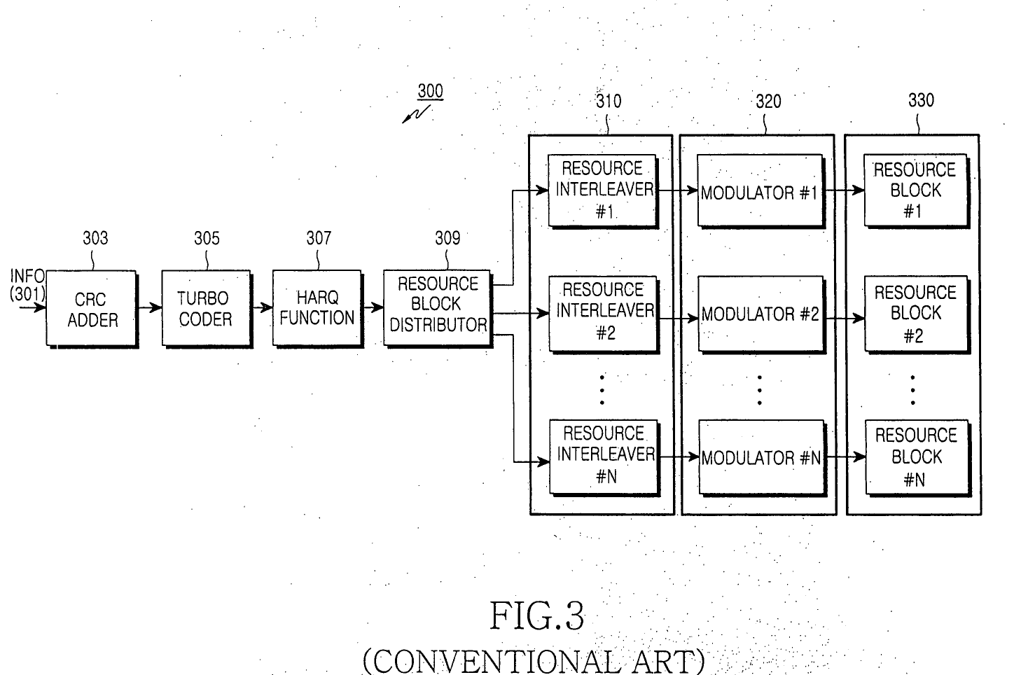

FIG. 3 is a block diagram illustrating a base station (BS) 300 in an OFDMA system according to an exemplary embodiment of the present invention. Referring to FIG. 3, a CRC adder 303 adds Cyclic Redundancy Check (CRC) bits for error check, to received user data 301, and delivers the CRC-added user data to a turbo coder 305. The turbo coder 305 codes the CRC-added user data 301. The coded data is composed of systematic bits which are user data, and parity bits which are additional information. The turbo coding process is not related to the gist of the present invention, so a description thereof will be omitted herein for clarity and conciseness.

A Hybrid Automatic Repeat reQuest (HARQ) function unit 307 receives the coded data from the turbo coder 305, and performs a HARQ function operation in a physical layer (Layer 1 or L1). The HARQ function unit 307 then selects the coded bits that it intends to transmit for a given transmission interval, among the received coded bits, to generate a sub-packet. Herein, the coded bits transmitted for the transmission interval are called a sub-packet.

A resource block distributor 309 receives the sub-packet generated by the HARQ function unit 307, and distributes the received sub-packet according to priority predetermined for a plurality of individual resource blocks allocated to a corresponding user. The priority is determined using the reliability obtained taking the channel situation or modulation scheme into consideration. A method for determining the priority will be described in detail hereinbelow.

A description will first be made of a method for allocating the generated sub-packet for each individual resource block. If the number of bits of the sub-packet output from the HARQ function unit 307 is 400, the number of resource blocks allocated to the user is 4, and the number of coded bits carried by each individual resource block is 100, the resource block distributor 309 services to distribute the 400 coded bits into 100-bit resource blocks according to a predetermined priority. The distributed coded bits are input to a plurality of resource block interleavers 310 where the bits are interleaved according to a specific rule. That is, the interleaving is performed for each individual resource block.

Herein, the reason for performing interleaving in each resource block is to increase decoding efficiency at a receiver for a burst error in the resource block because although there is a possibility that the channel situation may suffer a change even in one resource block, a transmitter cannot perceive the change.

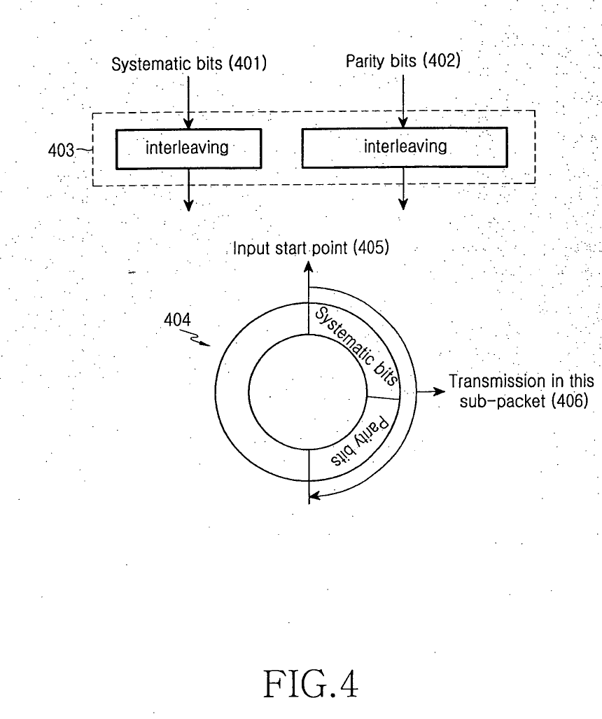

An exemplary method of allocating a sub-packet for each individual resource block will be described with reference to FIG. 4. Reference numerals 401 and 402 represent systematic bits and parity bits, respectively, in the output of the turbo coder 305. The systematic bits and the parity bits independently undergo an interleaving process as shown by reference numeral 403. In the interleaving process 403, the systematic bits are mixed (or permutated) among themselves according to a specific method, and the parity bits are mixed among themselves according to a specific method. The interleaving process 403 is omittable. The systematic bits and the parity bits, after undergoing the interleaving process 403, are input to a circular buffer 404. In this process, the systematic bits and the parity bits are sequentially input beginning at an input start point 405. In an exemplary implementation, the circular buffer 404 generates a sub-packet according to the number of coded bits that it can transmit in a current transmission interval. For example, if the number of coded bits that can be transmitted in the current transmission interval is 500, the circular buffer 404 generates a current sub-packet by sequentially cutting 500 bits clockwise beginning at the input start point 405.

Herein, the reason for performing interleaving for each individual resource block as proposed in the present invention instead of performing interleaving in units of sub-packets as done in the conventional technology is to guarantee performance improvement obtained taking a characteristic of the turbo coder into consideration. That is, if the interleaving is performed for each individual resource block according to an exemplary embodiment of the present invention, the systematic bits and the parity bits in the output of the HARQ function unit 307 can be independently allocated for each individual resource block without being mixed. Therefore, it is possible to allocate a part including the systematic bits to the resource block having a better channel environment. That is, the systematic bits can be transmitted through a better channel.

Modulators 320 of FIG. 3 receive the coded bits interleaved by the resource block interleavers 310, and perform a specific modulation process on the received coded bits. The modulated bits are allocated to each resource block 330 and then transmitted to a corresponding receiver.

Certain exemplary embodiments of the present invention have no regard for location of the modulators 320. That is, although the modulators 320 are located in the rear stage of the resource block interleavers 310 in the block diagram of the transmitter proposed by the present invention, they can also be located in the rear stage of the turbo coder 305.

A description will now be made of a method for allocating resource blocks according to priority by the resource block distributor 309.

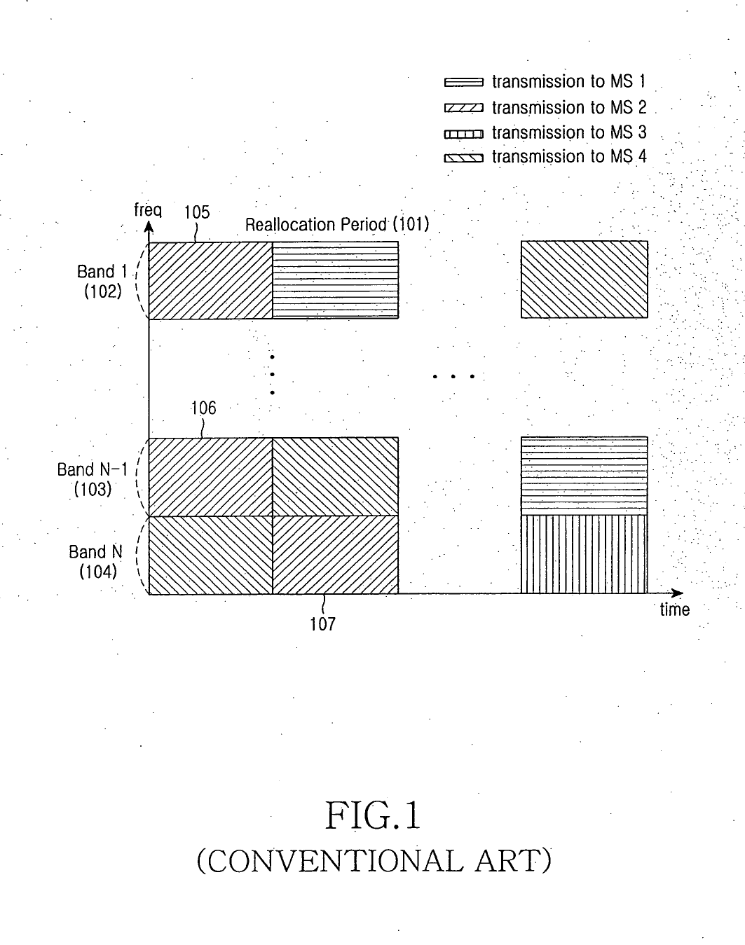

The resource block allocation method proposed by an exemplary embodiment of the present invention calculates priority according to communication systems. A first system can correspond to a FDMA system that allocates resource blocks with the sub-bands, and a second system can correspond to an OFDMA system that simultaneously allocates resource blocks according to the frequency band and the diversity resource as shown in FIG. 1.

In the first system, after receiving channel state information, a transmitter allocates a particular sub-band to a particular mobile station (MS) according to a scheduling algorithm. In an exemplary implementation, the channel state information is feedback information received from a MS, and can be a Channel Quality Indicator (CQI).

In the case where the number of sub-bands allocated to a particular MS is a plural number and the number of coded bits to be transmitted is too large for a single sub-band, the coded bits are distributed to a plurality of sub-bands before being transmitted. The number of the allocated sub-bands is defined as K, and reliability of a k^{th} sub-band is defined as γₖ (k=1 . . . K).

The higher reliability has a greater γₖ value. For example, γₖ can be considered as a Signal to Noise Ratio (SNR) of a k^{th} sub-band. So then, γₖ values can be ordered according to their levels. After the ordering, it is possible to transmit the coded bits beginning at the leading bit in order of the highest-reliability band. For example, 3 sub-bands of a^{th}, b^{th} and c^{th} sub-bands are allocated, and their reliabilities are defined as γₐ, γ_{b}, and γₑ, respectively. If γ_{b}>γₐ>γ_{c}, the highest-priority bit is carried on from the b^{th} band. The entire coded bits are divided into three parts, and the three parts are carried on the b^{th}, a^{th} and c^{th} bands, respectively.

In the OFDMA system, the sub-bands and the diversity resources are simultaneously allocated. The method of transmitting high-priority information through the high-reliability resource can be applied even to the case where different types of resources are used. In this case, a transmitter should provide a receiver with the information indicating the resource through which the high-priority information is transmitted and the resource through which the low-priority information is transmitted. In an exemplary implementation, the high-priority information can be the systematic bits, and the low-priority information can be the parity bits.

In the foregoing description, the reliability can be understood in several methods according to certain circumstances.

In a first method, the same modulation scheme is applied to all of a plurality of allocated bands. In this case, simply, a high-SNR band has the high reliability. Therefore, in this case, the SNR can be used as a criterion indicating reliability of the band.

In a second method, modulation schemes to be used for individual bands are different from each other. In this case, the SNR cannot be simply used as a criterion for the reliability. This is because when a modulation order is high even though the SNR is high, the reliability can be lower than when the modulation order is low, even though the SNR is low. Generally, the modulation order is determined by comparing the SNR value with thresholds. Commonly, a measured SNR value of a k^{th} band is denoted by βₖ, and thresholds of BPSK, QPSK, 16QAM and 64QAM are denoted by Th_{BPSK}, Th_{QPSK}, Th_{16QAM} and Th_{64QAM}, respectively. In an exemplary implementation, the threshold means a threshold used for determining a modulation scheme.

A relationship between the modulation schemes and the thresholds will be described below. For βₖ<Th_{QPSK}, BPSK modulation is used. For Th_{QPSK}<βₖ<Th_{16QAM}, QPSK modulation is used. For Th_{16QAM}<βₖ<Th_{64QAM}, 16QAM modulation is used. For Th_{64QAM}<βₖ, 64QAM modulation is used. In this case, the reliability can be determined according to a range of the βₖ using Equation (1) to Equation (4) below.

For βₖ<Th_{QPSK}, the reliability can be determined by
γₖ=βₖ, if βₖ<Th_{QPSK} (1)

For Th_{QPSK}<βₖ<Th_{16QAM}, the reliability can be determined by
γₖ=βₖ−Th_{QPSK}, if Th_{QPSK}<βₖ<Th_{16QAM} (2)

For Th_{16QAM}<βₖ<Th_{64QAM}, the reliability can be determined by
γₖ=βₖ−Th_{16QAM}, if Th_{16QAM}<βₖ<Th_{64QAM} (3)

For Th_{64QAM}<βₖ, the reliability can be determined by
γₖ=βₖ−Th_{64QAM}, if Th_{64QAM}<βₖ (4)

The relationship between the modulation schemes and the thresholds will generally be described below. That is, there is a function of determining reliability according to a modulation scheme, and this function determines mapping between a measured SNR value and the reliability.

If a BPSK modulation scheme is used, a function γₖ indicating the reliability can be represented by
γₖ=ƒ_{BPSK}(βₖ), if BPSK is used (5)

If a QPSK modulation scheme is used, a function γₖ indicating the reliability can be represented by
γₖ=ƒ_{QPSK}(βₖ), if QPSK is used (6)

If a 16QAM modulation scheme is used, a function γₖ indicating the reliability can be represented by
γₖ=ƒ_{16QAM}(βₖ), if 16QAM is used (7)

If a 64QAM modulation scheme is used, a function γₖ indicating the reliability can be represented by
γₖ=ƒ_{64QAM}(βₖ), if 64QAM is used (8)

Aside from the presented methods, there are also other possible methods. Although the reliability is defined in another method, there is no change in object and application of the present invention.

Meanwhile, if a receiver is allocated a plurality of frequency-time resources, it should have the information indicating in which the resource user data or additional information exists, and in which order the coded bits are transmitted in order to buffer the coded bits in the original order. Therefore, a base station needs to provide this information to a corresponding MS.

For example, a base station, when allocating a plurality of resources, can provide the information indicating in which order the high-priority bits are transmitted using order of the resources. When three sub-bands, A, B and C, are allocated, such information as the fields shown in Table 1 below is transmitted through a particular control channel. In other words, Table 1 shows an exemplary control message for the case where one type of resource is allocated.

Referring to Table 1, MAC ID indicates an ID of an MS, NUM_OF_RESOURCE_ASSIGNED indicates the number of allocated resources, and information of the succeeding NUM_OF_RESOURCE_ASSIGNED*N bits indicates NUM_OF_RESOURCE_ASSIGNED allocated N-bit resource. In this case, the high-priority information is transmitted beginning at the sub-band B according to allocated order of B, C and A.

TABLE 1

| Field Name | Size (bits) | Value |
|---|---|---|
| MAC ID | x | MS ID |
| NUM_OF_RESOURCE_ASSIGNED | M | 3 |
| RESOURCE ASSIGNED | N | B |
| RESOURCE ASSIGNED | N | C |
| RESOURCE ASSIGNED | N | A |
| . . . | | |

Unlike the case where one type of resource is allocated, it is also possible to provide the information using three resource allocation messages. Even in this case, locations of user data and parity bits can be determined according to priority.

If the diversity resources and the sub-band resources are simultaneously allocated, these can be transmitted to a MS through different signaling methods to optimize signaling. In this case, there is a need to define a 1-bit indicator to indicate the resource through which the high-priority bits are transmitted. Table 2 below shows an exemplary control message format for the case where the diversity resources and the sub-band resources are simultaneously allocated.

Referring to Table 2, if a SYSTEMATIC_BIT_LOCATION field is ‘1’, it means that high-priority bits are transmitted through a diversity channel, and if a SYSTEMATIC_BIT_LOCATION field is ‘0’, it means that the high-priority bits are transmitted through a sub-band. When a plurality of sub-band or diversity resources is simultaneously allocated, the priority is determined according to allocation order as described above.

TABLE 2

| Field Name | Size (bits) | Value |
|---|---|---|
| MAC ID | x | MS ID |
| SYSTEMATIC_BIT_LOCATION | 1 | 1: systematic to diversity resource |
| | | 0: systematic to sub-band |
| DIVERSITY_RESOURCE_ALLOCATION_BLOCK | variable | Diversity resource allocation |
| . . . | | signaling information |
| SUBBAND_RESOURCE_ALLOCATION_BLOCK | variable | Sub-band resource allocation |
| | | signaling information |

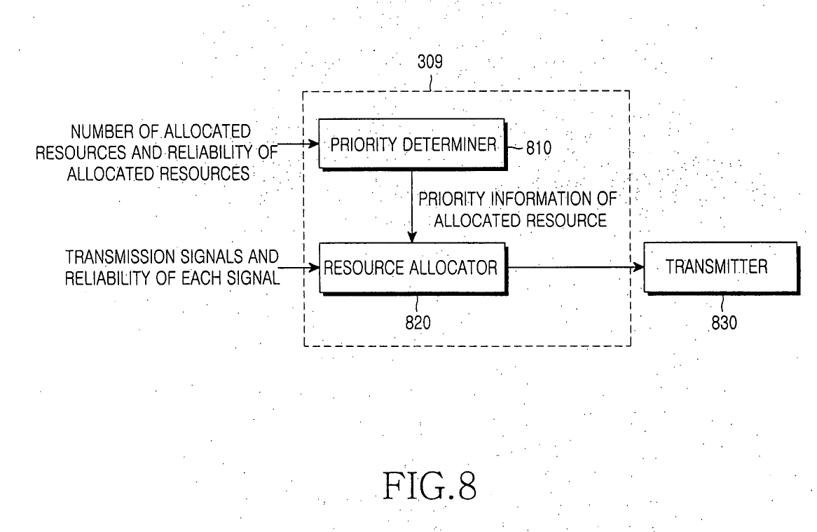

Next, with reference to FIG. 8, a description will be made of a structure of the resource block distributor 309 for allocating the resource blocks.

Referring to FIG. 8, the resource block distributor 309 includes a priority determiner 810 and a resource allocator 820. A transmitter 830 shown in FIG. 8 is a block constructed after the resource block distributor 309, and performs interleaving and modulation operations according to the present invention.

The priority determiner 810 determines through which it will transmit a high-priority signal depending on received information on the number of allocated resources and priority of the allocated resources. That is, the priority determiner 810 determines priority information of the allocated resources according to the priority. The priority is determined according to a range of βₖ. The range of βₖ is shown in Equation (1) to Equation (4). The priority determiner 810 delivers the determined priority information to the resource allocator 820. The resource allocator 820 allocates transmission signals beginning at the high-priority resources using the priority information of the allocated resources determined by the priority determiner 810. The resource allocator 820 allocates signals according to reliability of resources and priority of transmission signals, and then delivers the allocation results to the transmitter 830. The transmitter 830 converts the received information into a radio frequency (RF) signal, and transmits the RF signal to a receiver.

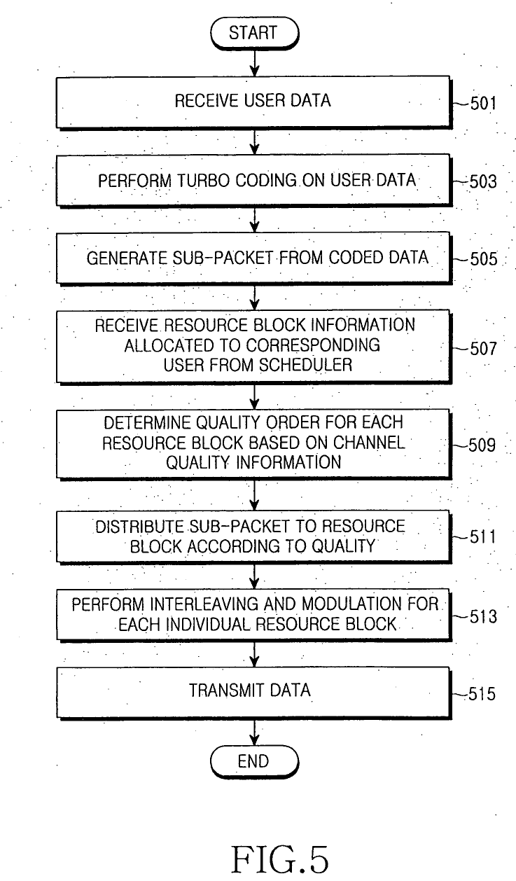

FIG. 5 is a flowchart illustrating a data transmission method in a transmitter 300 according to an exemplary embodiment of the present invention. Referring to FIG. 5, the transmitter 300 receives user data in step 501. The received user data selects a target MS to which a data packet is to be transmitted for the current transmission interval after undergoing scheduling by a scheduler (not shown). Thereafter, a turbo coder 305 performs turbo coding on the scheduled user data in step 503. Then a HARQ function unit 307 generates a sub-packet from the coded data in step 505.

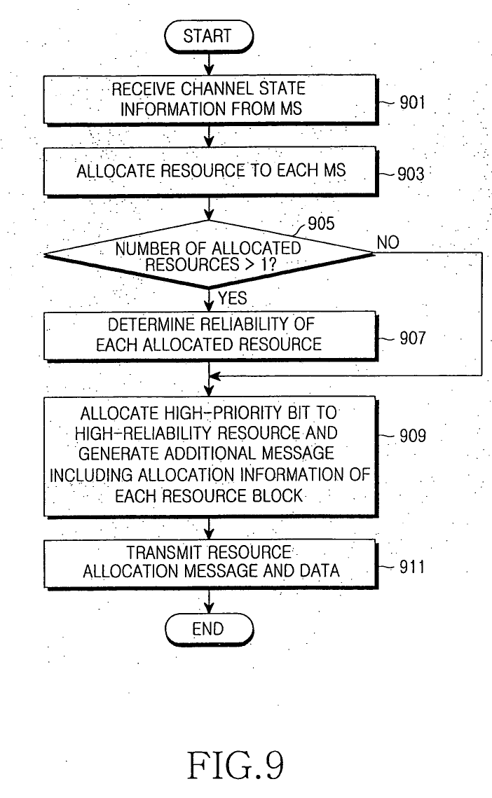

Thereafter, a resource block distributor 309 receives resource block information allocated to a corresponding user from the scheduler in step 507. As the resource block information includes channel quality information for each resource block, the resource block distributor 309 receiving the resource block information determines priority of the quality for each resource block based on the channel quality information in step 509. Thereafter, the resource block distributor 309 allocates the sub-packet to the resource block according to priority of the quality in step 511. In distributing the resource blocks, the resource block distributor 309 determines whether there are systematic bits, and if there are systematic bits, allocates the systematic bits to the resource block having a good channel quality. A method for allocating resource blocks according to the channel quality will be described hereinbelow with reference to FIG. 9.

After allocating the sub-packet for each individual resource block according to the priority, the transmitter 300 performs interleaving and modulation processes for each individual resource block in step 513, and transmits the data allocated for each individual resource block in step 515.

FIG. 9 is a flowchart illustrating a method for allocating by a transmitter 300 a sub-packet for each individual resource block and then transmitting data. Referring to FIG. 9, the transmitter 300 receives channel state information (or channel quality indicator (CQI)) from each MS in step 901. The transmitter 300 allocates resources to each MS according to the channel state in step 903. After allocating resources to each MS, the transmitter 300 outputs the number of allocated resources and the reliability of the allocated resources. In step 905, the transmitter 300 determines whether the number of allocated resources is greater than ‘1’, based on the number of allocated resources and the reliability of the allocated resources. If the number of allocated resources is less than or equal to ‘1’, the transmitter 300 proceeds to step 909 without the need to determine reliability. However, if the number of allocated resources is greater than ‘1’, the transmitter 300 determines reliability of each allocated resource in step 907. The reliability is determined according to a range of the βₖ. The operation of steps 905 and 907 is repeatedly performed for every MS by the transmitter 300.

Thereafter, in step 909, the transmitter 300 allocates high-priority bits to the high-reliability resource, and then generates a control message which is allocation information for the resource block. The control message is generated as shown in Table 1 or Table 2. That is, when one type of resource is allocated, the control message is configured as shown in Table 1, and when the diversity resources and the sub-band resources are simultaneously allocated, the control message is configured as shown in Table 2.

Thereafter, in step 911, the transmitter 300 transmits the generated control message and data to a corresponding MS.

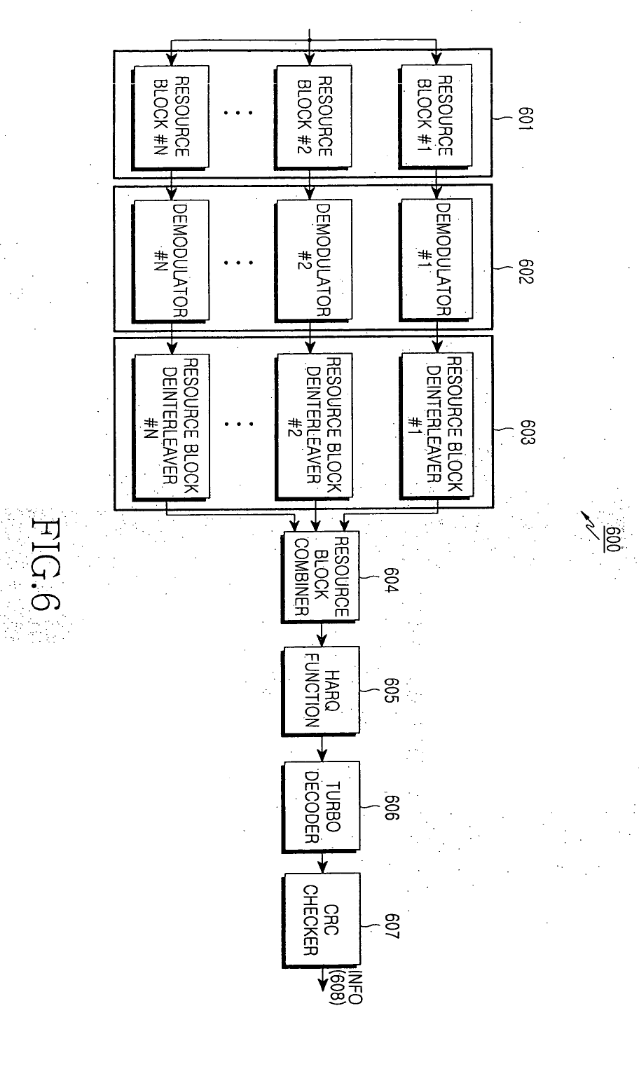

FIG. 6 is a block diagram illustrating a MS 600 in an OFDMA system according to an exemplary embodiment of the present invention.

Referring to FIG. 6, a MS 600 includes a plurality of demodulators 602 and resource block deinterleavers 603, all of which receive their associated resource blocks. Each of the demodulators 602 receives the data transmitted for each individual resource block 601, and demodulates the received data. Each of the resource block deinterleavers 603 receives a signal provided from its associated demodulator 602, and deinterleaves the received signal according to a specific rule. Because an exemplary embodiment of the present invention transmits the sub-packet for each individual resource block, the resource block deinterleavers 603 is located in a front stage of a resource block combiner 604.

The resource block combiner 604 combines the data received for each individual resource block deinterleaver 603 based on a control message transmitted from the transmitter 300. A HARQ function unit 605 performs a HARQ function in a physical layer on the received combined data. Upon completely receiving data from the HARQ function unit 605, a turbo decoder 606 and a CRC checker 607 decode the received data and perform a CRC on the decoded data.

Alternatively, the demodulators 602 may be located between the resource block combiner 604 and the HARQ function unit 605 according to the location of the modulators 320 of the transmitter 300.

Basically, the MS 600 transmits channel quality information CQI to the transmitter 300, but a structure for this is not separately shown herein.

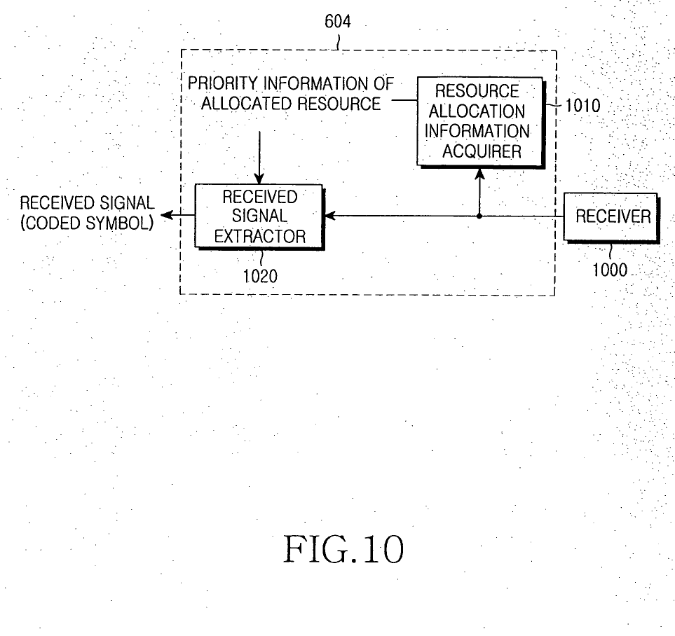

Next, with reference to FIG. 10, a description will be made of the resource block combiner 604. Referring to FIG. 10, the resource block combiner 604 includes a resource allocation information acquirer 1010 and a received signal extractor 1020. A receiver 1000 is schematically shown as a front stage of the resource block combiner 604.

The receiver 1000 demodulates a RF signal transmitted from the transmitter 300 into a baseband signal, and then provides the baseband signal to the resource allocation information acquirer 1010 and the received signal extractor 1020. The resource allocation information acquirer 1010 extracts a control message part for resource allocation from the signal provided from the receiver 1000, to acquire the information indicating through which resource the high-priority signals were transmitted. The acquired information is provided to the received signal extractor 1020. The received signal extractor 1020 receives the priority information of the allocated resource, provided from the resource allocation information acquirer 1010, receives the baseband signal from the receiver 1000, and extracts the received signal taking the priority information of the allocated resource into account.

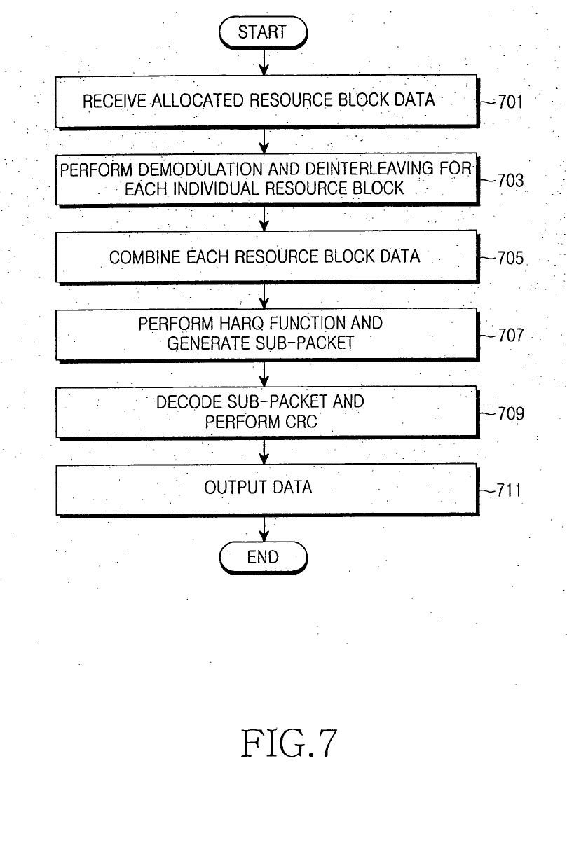

FIG. 7 is a flowchart illustrating a method for receiving data in an MS 600 according to an exemplary embodiment of the present invention.

Referring to FIG. 7, the MS 600 receives a control message and data of each individual resource block allocated thereto, from the transmitter 300, in step 701. Thereafter, the MS 600 performs demodulation and deinterleaving on a signal 601 received for each individual resource block in step 703. The resource block combiner 604 receiving the deinterleaved data for each individual resource block combines the control message and each resource block data in step 705. The MS 600 performs a HARQ function on the combined data and generates a sub-packet in step 707. The MS 600 performs decoding and a CRC on the generated sub-packet in step 709. If the CRC is passed, the MS 600 outputs user information 608 in step 711.

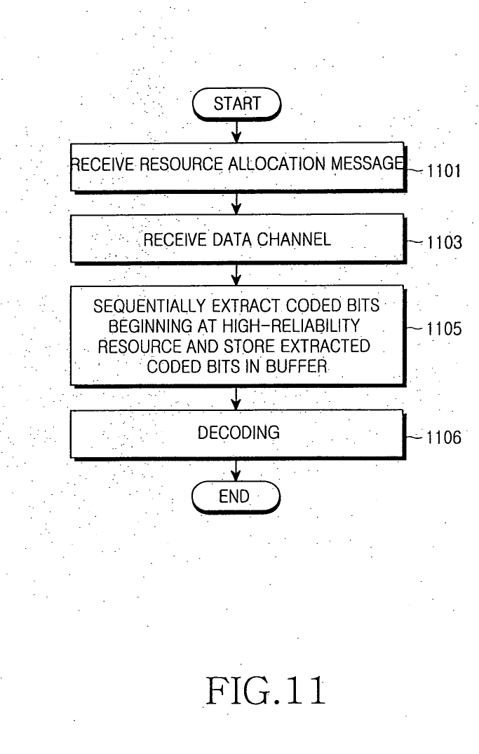

With reference to FIG. 11, a description will now be made of a method for combining, by the resource block combiner 604, data allocated for each individual resource block. Referring to FIG. 11, the resource block combiner 604 receives a resource allocation message, or a control message, transmitted from a transmitter 300, in step 1101. Thereafter, the resource block combiner 604 receives a data channel in step 1103. The resource block combiner 604 sequentially extracts coded bits beginning at the high-reliability resource based on the resource allocation message, and stores the extracted coded bits in a buffer, in step 1105. Thereafter, the receiver 600 decodes the data in step 1106, which is output from the resource block combiner 604 and stored in the buffer, in step 1105.

As can be understood from the foregoing description, the OFDMA system using a plurality of resource blocks according to the present invention allocates a sub-packet for each individual resource block and performs interleaving on the allocated sub-packet, thereby allocating systematic bits to a better resource block. In addition, in performing frequency domain scheduling, if there are a plurality of allocated frequency-time bands, the present invention reduces packet errors by differentiating a location of transmission data according to reliability of each resource, thereby improving reception performance. As a result, it is possible to increase data transmission and reception reliability, thereby contributing to an improvement in the entire system capacity.

The present invention can also be embodied as computer-readable codes on a computer-readable recording medium. The computer-readable recording medium is any data storage device that can store data which can thereafter be read by a computer system. Examples of the computer-readable recording medium include, but are not limited to, read-only memory (ROM), random-access memory (RAM), CD-ROMs, magnetic tapes, floppy disks, optical data storage devices, and carrier waves (such as data transmission through the Internet via wired or wireless transmission paths). The computer-readable recording medium can also be distributed over network-coupled computer systems so that the computer-readable code is stored and executed in a distributed fashion. Also, function programs, codes, and code segments for accomplishing the present invention can be easily construed as within the scope of the invention by programmers skilled in the art to which the present invention pertains.

While the invention has been shown and described with reference to a certain exemplary embodiments thereof, it will be understood by those skilled in the art that various changes in form and details may be made therein without departing from the spirit and scope of the invention as defined by the appended claims.

What is claimed is:

1. A transmission method in an Orthogonal Frequency Division Multiple Access (OFDMA) system using a plurality of resource blocks, the method comprising:
generating a sub-packet for performing a Hybrid Automatic Repeat reQuest (HARQ) function on channel-coded data;
distributing the sub-packet to each resource block;
interleaving the sub-packet distributed to each resource block; and
transmitting the interleaved sub-packet to a receiver.

2. The transmission method of claim 1, further comprising determining order of a plurality of allocated resource blocks according to reliability.

3. The transmission method of claim 1, further comprising generating a control message including distribution information of the sub-packet, and transmitting the generated control message to a receiver.

4. The transmission method of claim 2, wherein the reliability determined in the determining of the order comprises:
measuring a signal-to-noise ratio (SNR) of resource blocks based on channel state information received from the receiver; and
determining reliability according to the SNR and a modulation scheme of the sub-packet.

5. The transmission method of claim 3, wherein the control message comprises information comprising a number of allocated resource blocks and distribution order of the sub-packet.

6. A transmitter in an Orthogonal Frequency Division Multiple Access (OFDMA) system using a plurality of resource blocks comprising:
a Hybrid Automatic Repeat reQuest (HARQ) function unit for generating a sub-packet to perform a HARQ function on channel-coded data;
a resource block distributor for distributing the sub-packet to each resource block; and
a plurality of resource block interleavers for interleaving the sub-packet distributed to each resource block.

7. The transmitter of claim 6, further comprising:
a controller for generating a control message including a distribution information of the sub-packet; and
a transmission unit for transmitting the generated control message to a receiver.

8. The transmitter of claim 6, wherein the resource block distributor comprises:
a priority determiner for determining order of allocated resource blocks according to reliability based on channel state information received from the receiver; and
a resource allocator for distributing the sub-packet to each resource block based on the determined order.

9. The transmitter of claim 8, wherein the reliability is determined according to a signal-to-noise ratio (SNR) of allocated resource blocks and a modulation scheme of the sub-packet.

10. The transmitter of claim 7, wherein the control message comprises information comprising a number of allocated resource blocks and distribution order of the sub-packet;

11. A reception method in an Orthogonal Frequency Division Multiple Access (OFDMA) system using a plurality of resource blocks, the method comprising:
receiving a data to each resource and a control message including distribution information of data from a transmitter, and deinterleaving the data distributed to each resource block;
combining the data deinterleaved for each resource block based on the control message, and outputting a sub-packet;
performing a Hybrid Automatic Repeat reQuest (HARQ) function on the sub-packet; and
decoding the sub-packet that underwent the HARQ function.

12. The reception method of claim 11, further comprising performing Cyclic Redundancy Check (CRC) on the decoded data.

13. The reception method of claim 8, wherein the control message comprises information comprising a number of allocated resource blocks and distribution order of the sub-packet.

14. A receiver of an Orthogonal Frequency Division Multiple Access (OFDMA) system using a plurality of resource blocks, comprising:
a reception unit for receiving a data distributed to each resource, and an control message including distribution information of the data from a transmitter;
a plurality of resource block deinterleavers for deinterleaving the data to each resource block;
a resource block combiner for combining the data deinterleaved for each resource block based on the control message, and outputting a sub-packet;
a Hybrid Automatic Repeat reQuest (HARQ) function unit for performing a HARQ function on the sub-packet; and
a decoder for decoding the sub-packet that underwent the HARQ function.

15. The mobile station of claim 14, further comprising a Cyclic Redundancy Check (CRC) checker for performing a CRC on the decoded data.

16. The receiver of claim 14, wherein the resource block combiner comprises:
a resource allocation information acquirer for determining order of the each resource block based on the control message; and
a received signal extractor for combining the sub-packet deinterleaved for each resource block based on the order provided from the resource allocation information acquirer.

17. The receiver of claim 14, wherein the control message comprises information comprising a number of allocated resource blocks and distribution order of the sub-packet.

18. A method for transmitting data in an Orthogonal Frequency Division Multiple Access (OFDMA) system using a plurality of resource blocks, the method comprising:
determining order of allocated resource blocks according to reliability of allocated resources;
distributing data to be transmitted to the receiver to a resource block according to the order;
generating a control message including distribution information of the data; and
transmitting the data and the control message to the receiver.

19. The method of claim 18, wherein the reliability is determined according to a range of a measured signal-to-noise ratio (SNR) βₖ of a k^{th} band.

20. The method of claim 19, wherein the SNR βₖ of a k^{th} band comprises βₖ<Th_{QPSK}, in which the reliability is determined by
γₖ=βₖ, if βₖ<Th_{QPSK}
where Th_{QPSK} denotes a threshold of Quadrature Phase Shift Keying (QPSK).

21. The method of claim 19, wherein the SNR βₖ of a k^{th} band comprises Th_{QPSK}<βₖ<Th_{16QAM}, in which the reliability is determined by
γₖ=βₖ−Th_{QPSK}, if Th_{QPSK}<βₖ<Th_{16QAM}
where Th_{QPSK} denotes a threshold of QPSK, and Th_{16QAM} denotes a threshold of 16-ary Quadrature Amplitude Modulation (16QAM).

22. The method of claim 19, wherein the SNR βₖ of a k^{th} band comprises Th_{16QAM}<βₖ<Th_{64QAM}, in which the reliability is determined by
γₖ=βₖ−Th_{16QAM}, if Th_{16QAM}<βₖ<Th_{64QAM}
where Th_{16QAM} denotes a threshold of 16QAM, and Th_{64QAM} denotes a threshold of 64-ary Quadrature Amplitude Modulation (64QAM).

23. The method of claim 19, wherein the SNR βₖ of a k^{th} band comprises Th_{64QAM}<βₖ, in which the reliability is determined by
γₖ=βₖ−Th_{64QAM}, if Th_{64QAM}<βₖ
where Th_{64QAM} denotes a threshold of 64QAM.

24. A transmitter in an Orthogonal Frequency Division Multiple Access (OFDMA) system using a plurality of resource blocks, comprising:
a priority determiner for determining order of allocated resource blocks according to reliability of the allocated resources;
a resource allocator for distributing data to be transmitted to receiver to a resource block according to the order, and generating a control message including distribution information of the data; and
a transmission unit for transmitting the data and the control message.

25. A receiver in an Orthogonal Frequency Division Multiple Access (OFDMA) system using a plurality of resource blocks, comprising:
a reception unit for receiving a signal from a transmitter and converting the received signal into a baseband signal;
a resource allocation information acquirer for extracting a control message including distribution information of data in the converted signal, and acquiring order information of an allocated resource; and
a received signal extractor for sequentially extracting received signals from the allocated resource according to the order information of the allocated resource.

26. A computer-readable recording medium storing a computer-readable code for performing a method for transmitting and receiving data in an Orthogonal Frequency Division Multiple Access (OFDMA) system that allocates channel-coded data to a plurality of resource blocks, the method comprising:
generating, by a base station, a sub-packet to perform a Hybrid Automatic Repeat reQuest (HARQ) function on the data;
performing interleaving on the generated sub-packet for each resource block for a particular mobile station according to priority;
transmitting an additional message including the sub-packet for each resource block and allocation information of the sub-packet to mobile stations;
deinterleaving, by the mobile station, the sub-packet received from the base station for each resource block; and
combining the deinterleaved sub-packet based on the additional message.
